(19) United States
(12) Patent Application Publication
(10) Pub. No.: US 2016/0224353 A1
(43) Pub. Date: Aug. 4, 2016

(54) METHOD AND APPARATUS FOR GENERATING A PLURALITY OF GRAPHICAL USER INTERFACES

(71) Applicant: BELEGIN LIMITED, Hong Kong (CN)

(72) Inventors: Richard Mark Cohen, Hong Kong (CN); Nigel James Hamilton Reid, Hong Kong (CN)

(21) Appl. No.: 15/021,109

(22) PCT Filed: Aug. 28, 2014
(86) PCT No.: PCT/IB2014/064113

§ 371 Date: Mar. 10, 2016

(30) Foreign Application Priority Data
Sep. 10, 2013 (GB) 1316075.9

(51) Int. Cl. G06F 9/44; G06F 3/0482; G06F 3/0484; G06F 17/30

(52) U.S. Cl. CPC G06F 9/4443; G06F 17/30598; G06F 3/0482; G06F 3/04847

(57) ABSTRACT

There is provided a method of operating a computer system in order to generate a plurality of graphical user interfaces. The method comprises storing a common data set comprising a plurality of data objects, each data object indicating a type for the data object, and storing graphical user interface generation information for each of the plurality of graphical user interfaces, the graphical user interface generation information of each graphical user interface defining a type of graphical user interface element that is to be used to represent each data object type on the graphical user interface. The method further comprises, upon receipt of a request for one of the plurality of graphical user interfaces, creating one or more graphical user interface elements for each data object in the common data set, wherein the type of graphical user interface elements created for a data object is determined using the corresponding graphical user interface generation information.

The present invention relates to methods and apparatus for generating a plurality of graphical user interfaces.

Over the last decade rapid advances in technology have lead to a phenomenal growth in Internet usage. In particular, access to the Internet has become easier and much more widespread due largely to the prevalence of wireless Internet technologies (such as Wi-Fi, 3G etc), the availability of public Wi-Fi zones (often free) and mobile broadband services, and the availability of computer devices that are increasingly portable and intuitive to use, such as smart phones and tablet computers. Furthermore, this increased Internet usage is both a result and a cause of the growth in popularity of social media and social networking websites and applications.

Unsurprisingly, businesses now recognise the importance of the Internet, and associated technologies such as email, as a medium via which they can both advertise and sell their products and/or services. For example, most businesses now have a website and social media profiles, provide e-commerce facilities, and make use of email advertising, Internet/website advertising, sponsored search engine results etc. In addition, many businesses provide apps that allow users to quickly and easily access functions that are specific to the particular business. In this regard, the term “app” refers to a software application/program that is typically intended to run on a portable computer device such as a smart phone or tablet computer. However, given their popularity with users, the use of apps as a means for providing functionality has expanded to other devices, such as desktop computers and Internet-enabled televisions. Moreover, an app usually provides a relatively narrow set of functions relating to a specific service, tool, or business. Some examples of typical apps include email apps, calendar apps, gaming apps, location-based apps, banking apps, web apps etc.

In addition, in order to generate interest and attract potential customers, many businesses make use of the wide-audience that can be reached via the Internet and associated technologies to provide offers for free or reduced cost products and/or services. This is illustrated by the current prevalence of specialist Internet-based offers/deals services. These services bring together offers/deals from numerous vendors/merchants/service providers, referred to herein more generally as “merchants”, that can then be accessed by members of the public, thereby attracting subscribers/visitors/customers by accumulating a large number of offers for a variety of products and/or services in one location.

Typically, in order to find offers that they may be interested in claiming, customers/consumers must visit an offers website and browse through the available offers. Very often the customers/consumers must trawl through a maze of offers including many that are of no interest to them and that are in no way related to offers that led to their original decision to visit the website. Requiring customers to browse through all of the offers available via an offers website each time they visit the website will often discourage customers from returning to the offers website[?], as this is a repetitive and largely inefficient task that quickly begins to frustrate customers. As an alternative, some offers websites allow customers to sign-up/subscribe to the website so that they can receive emails notifying them of offers that may potentially be relevant to them. In order to identify offers that may be relevant to a customer, such an offers website will require that the customer provide them with at least some preference-related information (e.g. personal information and/or indications of interests). For example, the customer will typically be required to provide at least their location, their age/date of birth, and some indication as to their interests. The provider of the Internet-based offers service then uses this information to filter through the available offers, and generates an email that is sent to the customer with information regarding the offers that have been identified as relevant to that customer and links to these offers on the website. However, even when customers have initially chosen to subscribe to an offers website and thereby receive regular email notifications, it is often the case that, sooner or later, such permissions are eventually exploited and customers become bombarded with too many offers which in the worst case become increasingly irrelevant to their preferences and all the more so when their email details are passed onto organisations other than the original provider of the Internet-based offers/deals services. Accordingly, customers quickly tire of reviewing the information provided in such over frequent or unwanted regular email updates and begin to treat these as e-mail ‘spam’; deleting the emails as they are received, assigning them to ‘junk’ email folders without reading them, or even unsubscribing from the service.

It would therefore be desirable to provide a Internet-based offers system in which the graphical user interfaces provided by the system present customers/subscribers with an individually relevant set of offers, rather than by sending regular email notifications. By way of example, a graphical user interface can take the form of a webpage displayed in a web browser run on an Internet-enabled device (e.g. a desktop or laptop computer, tablet, mobile phone, Internet-enabled TV etc), or the interactive display presented by an app run on an Internet-enabled device (e.g. a desktop or laptop computer, tablet, mobile phone, Internet-enabled TV etc). In addition, it would also be desirable to improve the extent to which the offers presented to a subscriber are relevant to them.

To do so, an Internet-based offers system would need to require that subscribers provide them with at least some preference-related information with which to filter the available offers, and would also need to ensure that a merchant that is making an offer available using the web-based offers system defines a number of criteria that should be met by those subscribers to whom the offer is presented. The Internet-based offers system could then match the filter criteria defined by a merchant for an offer with the information provided by the subscribers in order to identify those subscribers for whom the offer is likely to be relevant and of interest.

In order to allow subscribers to provide their preference-related information to the Internet-based offers system, the system would need to provide a subscriber input graphical user interface (GUI) (e.g. a registration webpage or app window) that presents subscribers with requests for the required information and means for providing their responses. In addition, in order to enable merchants to provide the Internet-based offers service with the criteria they deem appropriate for a particular offer, the system would need to provide a separate merchant input GUI that presents merchants with the available criteria and means for accepting the merchant's selections thereof.

In this regard, the criteria available for selection by the merchants would need to correspond with the information that can be obtained from the subscribers in order to make filtering possible, such that both the subscriber input and merchant input GUIs would be at least partially based on the same data (i.e. the preference-related information/filter criteria). For example, to provide preference-related information, the subscriber input GUI would typically be required to allow subscribers to select one or more predefined values within one or more predefined categories of information, and the merchant input GUI would then allow merchants to define filter criteria by selecting from the same predefined values within the same predefined categories of information. However, given that each GUI provides a different function, they will each utilise different means to implement these selections. Conventionally, this would require that the system stores entirely separate sets of GUI data for each GUI, including duplicates of the predefined categories and the associated predefined values, which unnecessarily consumes system memory. Furthermore, if the predefined categories and/or the associated predefined values are extended, restricted or otherwise modified, the data associated with each GUI would need to be individually updated/modified in order to be consistent with the modified information. However, individually updating each GUI in this way is time consuming, and provides a possible source of error due to the risk of inconsistencies

It is therefore desirable to provide a system that can generate a number of different graphical user interfaces that are all at least partially based on common data and that each provide different functionality in respect of that data, without having to store duplicates of the common data for each graphical user interface, thereby reducing the volume of memory required to store the graphical user interface data, reducing the burden on the administrators of the system, and reducing the risk of errors/failures that could occur due to inconsistencies between the graphical user interfaces.

Therefore, according to a first aspect there is provided a method of operating a computer system in order to generate a plurality of graphical user interfaces. The method comprises storing a common data set comprising a plurality of data objects, each data object indicating a type for the data object, and storing graphical user interface generation information for each of the plurality of graphical user interfaces, the graphical user interface generation information of each graphical user interface defining a type of graphical user interface element that is to be used to represent each data object type on the graphical user interface. The method further comprise, upon receipt of a request for one of the plurality of graphical user interfaces, creating one or more graphical user interface elements for each data object in the common data set, wherein the type of graphical user interface elements created for a data object is determined using the corresponding graphical user interface generation information.

The step of creating one or more graphical user interface elements for each data object in the common data set may comprise, for each data object in the common data set, identifying the data object type, using the corresponding graphical user interface generation information to determine the type of graphical user interface element that is to be used to represent the identified data object type, and creating one or more graphical user interface elements of the determined type.

Each of the plurality of data objects may include one or more sets of data values. Then, for each data object in the common data set, a graphical user interface element may be created for each of the one or more sets of data values included in the data object.

Each of the plurality of data objects may relate to a category of data. Each of the one or more sets of data values included in a data object that relates a category of data may then comprise values that relate to a sub-category of said category of data.

A graphical user interface element may be an interactive control that displays and allows the selection of one or more data values.

According to a second aspect there is provided a computer program comprising computer readable code which, when run on a computer device, causes the computer device to perform the method according to the first aspect.

According to a third aspect there is provided a computer program product comprising a computer readable medium and a computer program according to the second aspect, wherein the computer program is stored on the computer readable medium.

According to a fourth aspect there is provided a system for generating a plurality of graphical user interfaces. The system comprises a memory configured to store a common data set comprising a plurality of data objects, each data object indicating a type for the data object. The memory is also configured to store graphical user interface generation information for each of the plurality of graphical user interfaces, the graphical user interface generation information of each graphical user interface defining a type of graphical user interface element that is to be used to represent each data object type on the graphical user interface. The system further comprises a processor configured to, upon receipt of a request for one of the plurality of graphical user interfaces, create one or more graphical user interface elements for each data object in the common data set, including using the corresponding graphical user interface generation information to determine the type of graphical user interface element to be created for a data object.

The processor may be configured to, for each data object in the common data set, identify the data object type, use the corresponding graphical user interface generation information to determine the type of graphical user interface element that is to be used to represent the identified data object type, and create one or more graphical user interface elements of the determined type.

Each of the plurality of data objects stored in the memory may include one or more sets of data values. The processor may then be configured to create a graphical user interface element for each of the one or more sets of data values included in each data object in the common data set.

The processor may be configured to generate graphical user interface elements that provide an interactive control that displays and allows the selection of one or more data values.

The present invention will now be more particularly described by way of example only with reference to the accompanying drawings, in which:

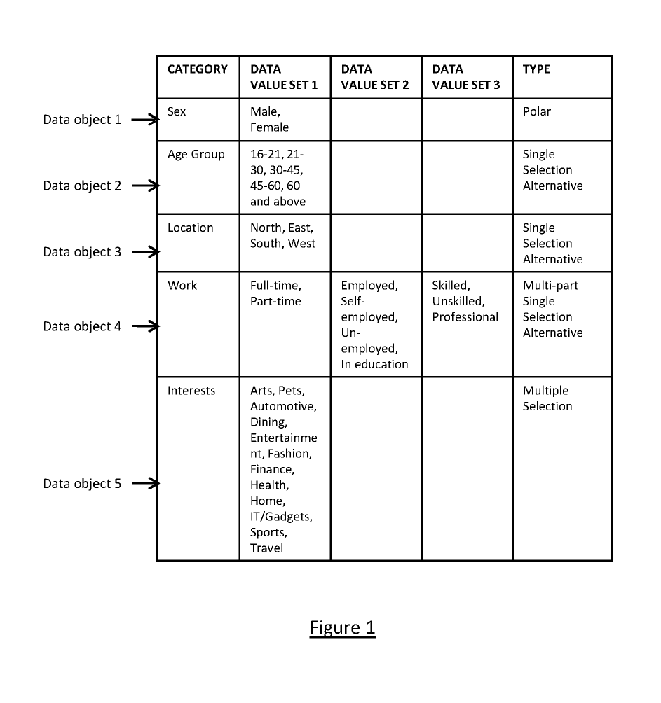

FIG. 1 illustrates an example of a common data set that comprises a plurality of data objects;

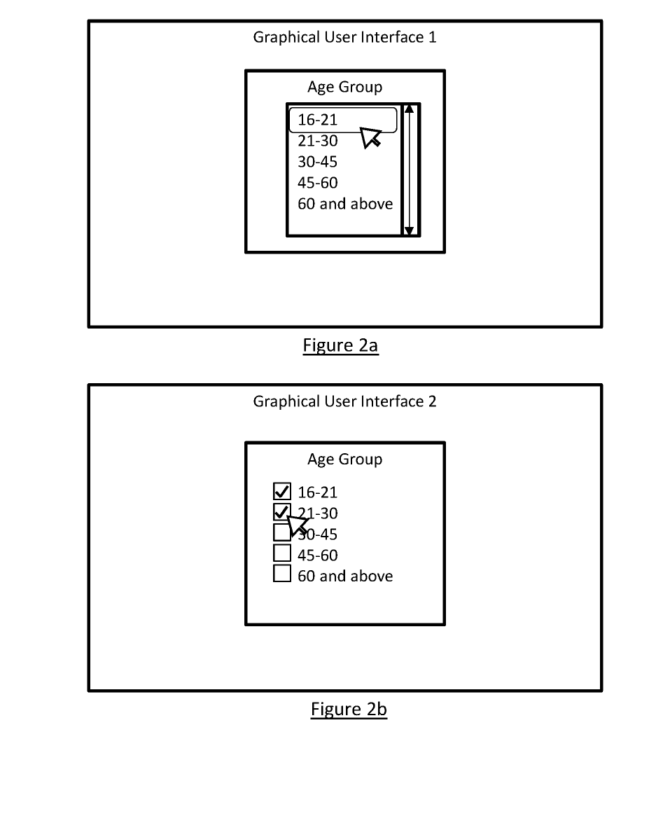

FIG. 2a illustrates an example of the representation of a data object on a first graphical user interface

FIG. 2b illustrates an example of the representation of the same data object on a second graphical user interface;

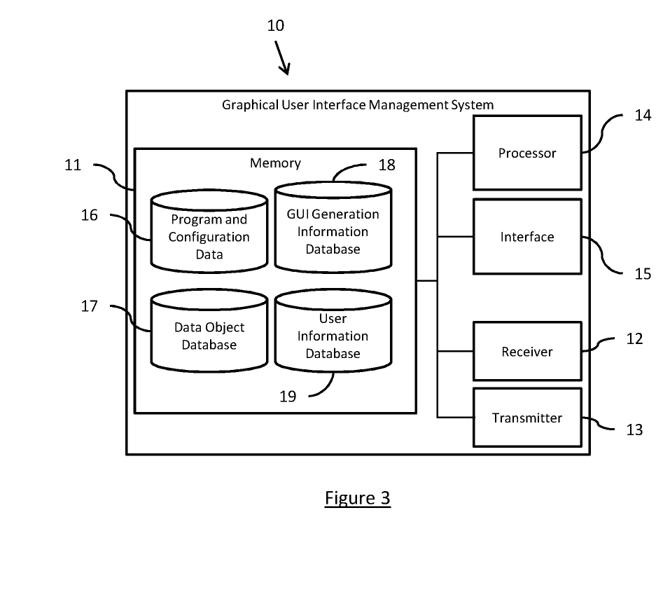

FIG. 3 illustrates schematically an embodiment of a system suitable for implementing the methods described herein; and

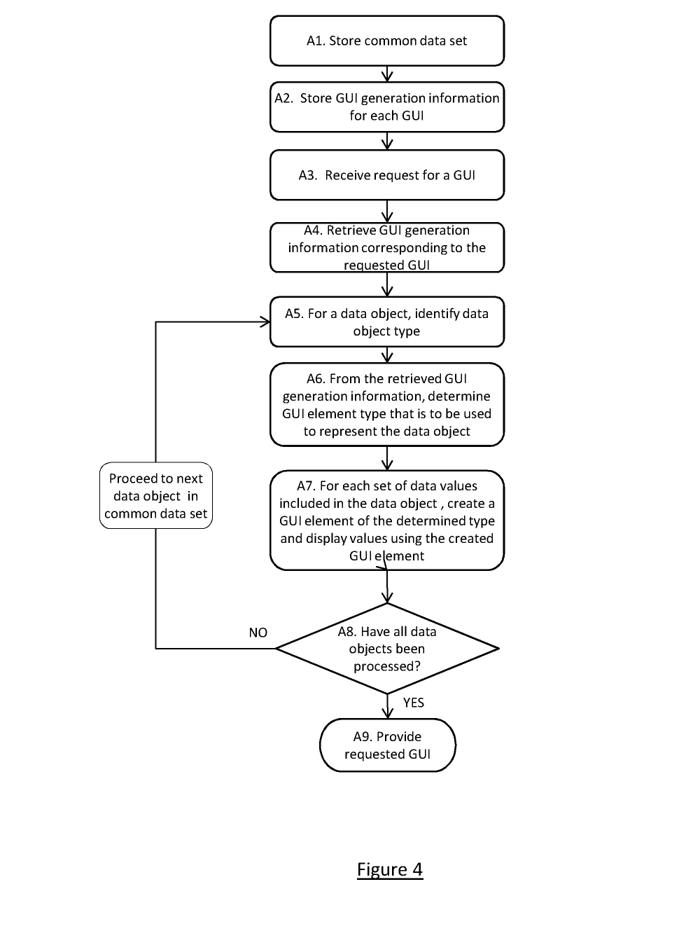

FIG. 4 is a flow diagram illustrating an embodiment of a method of generating a plurality of graphical user interfaces in accordance with the methods described herein.

There will now be described a system that enables a plurality of graphical user interfaces (GUI) to be generated from a single common data set, even when the GUIs are required to implement components of the common data set differently. To do so, the system stores a single copy of the common data set as a plurality of data objects, wherein each data object indicates a type for the data object (i.e. an indication as to the type of data provided by the data object). The system also stores GUI generation information for each of the plurality of GUIs, wherein the GUI generation information of each GUI defines a type of GUI element that is to be used to represent each data object type on the GUI. Then, when the system is required to generate any one of the plurality of GUIs for display to a user of the system (e.g. upon receipt of a request for one of the plurality of GUIs), the system creates one or more GUI elements for each object in the common data set, wherein the type of GUI element created for a data object is determined using the corresponding GUI generation information. In other words, when generating a GUI, for each data object in the common data set, the system identifies the data object type, uses the corresponding GUI generation information to determine the type of GUI element that is to be used to represent the identified data object type, and creates one or more GUI elements of the determined type.

The GUI generation information stored for each of the plurality of GUIs will typically take the form of a file containing computer code that defines the structure of the GUI together with additional data such as text, images, hyperlinks etc. This GUI generation computer code can then define an iterative procedure in which each data object in the common data set is processed in order to generate one or more GUI elements to represent the data object, and will also define a type of GUI element that is to be used to represent each type of data object on the GUI.

In this regard, each data object will typically relate to a particular category of data that is to be represented on the webpage, and will therefore include one or more sets/groups of data values. In other words, each set of data values included in a data object will include values that relate to a particular category of data. In this case, for a data object that relates to a particular category of data and that includes more than one set of data values, each set of data values will relate to a sub-category within that category. For example, FIG. 1 illustrates an extract from a database containing a plurality of data objects. In the example of FIG. 1, the second data object (data object 2) includes data relating age groups, and therefore specifies a title/subject that identifies the category of the data object as “Age Group” and includes a single set of data values defining available age groups (e.g. “16-21, 21-30, 30-45, 45-60, 60 and above”). The fourth data object (data object 4) of the example of FIG. 1 includes data relating to employment status, and therefore specifies a title/subject that defines the category of the data object as “Work” and includes three sets of data values. This data object has several sets of data values as each set relates to a different sub-category of data values that fall within the top level category.

The ‘type’ field included in a data object in the database can have any value provided that the GUI generation information that is stored for each of the GUIs provided by the system defines a corresponding type of GUI element. For example, in FIG. 1, each data object includes a ‘type’ field that specifies data types using corresponding terminology (e.g. “polar”, “single selection alternative”, “multi-part single selection alternative”, “multiple selection” etc). Alternatively, the ‘type’ field included in each data object could simply provide an identifier that indicates the data object type (e.g. “1”=polar, “2”=single selection alternative, “3”=multi-part single selection alternative etc) and for which a corresponding type of GUI element is defined in the GUI generation information corresponding to each of the GUIs.

As the system stores a database containing a single common data set that is to be used to generate each of a plurality of GUIs, the system need only store minimal GUI generating information for each GUI, without the need to duplicate the common data within the GUI generating information of each GUI. This reduces the amount of memory that is required in order to store all of the GUIs. In addition, as each of the GUIs is generated from a single source copy of the common data, any updates or modifications of the common data need only be made once, to this single copy, and will automatically propagate to each of the GUIs as and when they are generated. This reduces the burden on the administrators of the system, and reduces the risk of inconsistencies that could otherwise result in errors/failures. Furthermore, as the GUI generation information associated with each of the GUIs specifies the type of GUI element that is to be used to implement each data object type that is used by the system, each GUI can represent each of the data objects in the common data set differently, thereby allowing each GUI to provide different functionality based on a common set of data.

Each GUI element that is used to represent a particular data object will typically comprise an interactive graphic or control, typically referred to as a “widget”, that displays and allows the selection of one or more data values. For example, the GUI elements that can be implemented by the system can include, but are not limited to, check boxes, radio buttons, split buttons, sliders, list boxes, spinners, drop-down lists, text boxes, combo boxes, etc.

By way of example, FIG. 2a illustrates the representation of the second data object (data object 2), discussed above in relation to FIG. 1, on a first GUI (Graphical User Interface 1) generated by the system. FIG. 2b then illustrates the representation of the same data object on a second GUI (Graphical User Interface 2). In this example, data object 2 indicates a data object type of “single selection alternative”, and the GUI generation information used in generating Graphical User Interface 1 specifies that a data object of this data object type is to be represented using drop-down lists/boxes, wherein a drop-down list displays a list of value and allows a user to select one value from the list. When generating Graphical User Interface 1, the system therefore represents data object 2 using a drop-down list with the title/subject of the data object displayed adjacent to the drop-down list and the set of data values included in the data object displayed in the list, as illustrated in FIG. 2a. In contrast, the GUI generation information used to generate Graphical User Interface 2 specifies that a data object of this data object type is to be represented using check boxes, wherein a value is displayed adjacent to a check box and allows a user to select or deselect the value. A series of check boxes therefore allows a user to select one or more values from a set of values. When generating Graphical User Interface 2, the system therefore represents data object 2 using a number of check boxes, one for each value in the set of data values, each having a caption/text label displaying the corresponding data value, and displays the title/subject of the data object displayed adjacent to the check boxes, as illustrated in FIG. 2b. For example, this may be desirable if the first GUI is intended to obtain information relating to the age group of a subscriber to an Internet-based offers service, who will therefore be required to make a single selection, whilst the second GUI is intended to allow a merchant user to define one or more age groups to which subscribers must belong in order for an offer to be presented to them, and who will therefore want to make one or more selections.

FIG. 3 illustrates schematically an embodiment of a GUI management system 10 suitable for implementing a plurality of GUIs in accordance with the methods described herein. The system 10 can be implemented as a combination of computer hardware and software, and comprises a memory 11, a receiver 12, a transmitter 13, a processor 14 and an interface 15. Whilst the system 10 has been illustrated schematically as single unit (e.g. server or computer device) comprising a single occurrence of each of the functional elements listed above, the system could equally comprise multiple occurrences of each functional element and could equally be provided by a plurality of separate units that cooperate to provide the required functionality. By way of example, separate aspects of the functionality of the system could be distributed between a number of separate servers or computer devices, such that a first group of one or more servers/computer devices implements all of the necessary processing and interface functions whilst a second group of one or more servers/computer devices provides database functionality (e.g. including storage, security, data integrity, data redundancy etc). As a further example, certain aspects of the functionality of the system could be distributed one or more servers and a remote computer device (e.g. desktop computer, laptop computer, mobile/smart phone, tablet, Internet-enabled TV etc). The memory 11 typically stores the various programs/executable files that are implemented by the processor 14, any system configuration data 16, and any other data that may be of use to the system 10. In particular, the data stored by the memory 11 can include but is not limited to a data object database 17 that stores a common data set comprising a plurality of data objects, and a GUI generation information database 18 that stores a GUI generation information file for each of the GUIs that are provided by the system. The data stored by the memory 11 can also include user information database 19.

For example, if the system was to be used to provide an Internet-based offers service, this user information database 19 could contain a subscriber profile for each of the subscribers/customers that use the system to view and claim offers, and a merchant profile for each of the merchants that use the system to make offers available to the subscribers. A subscriber profile would then typically be configured to store the subscriber's login information (e.g. username and password), the subscriber's contact information (e.g. email address, physical address, phone number etc), the subscriber's preference-related information obtained using the subscriber input webpage, and optionally details of any offers claimed by the subscriber. A merchant profile would then typically be configured to store the merchant's login information (e.g. username and password), the merchant's contact information (e.g. email address, physical address, phone number etc), and details of any offers made available by the merchant including the criteria defined by the merchant for each offer.

The receiver 12 is configured to receive data that is sent to the system 10. For example, this data will typically comprise Internet-based communications from users of the system, such as data inputs supplied to each of the plurality of GUIs implemented by the system 10. The transmitter 13 is configured to send data from the system 10. For example, this data will typically comprise Internet-based communications intended for users of the system, such as data relating to each of the plurality of GUIs implemented by the system and responses to received data inputs. If desired, the transmitter 13 and the receiver 12 could be used to send/receive other types of communications such as SMS/text messages etc.

The processor 14 is configured to implement the processing necessary to provide each of the plurality of GUIs implemented by the system in accordance with the methods as described herein. As such, the processor 14 is configured to implement any of the functionality required in order to execute any of the processes, perform any of the actions, and maintain any items of data described herein. In particular, the processor is 14 is configured to generate a GUI using the GUI generation information and the common data set stored in the memory 11.

The interface 15 is configured to allow users to interact with the system 10 (e.g. in order to sign-up to the system, view/update/modify any appropriate data etc) via each of the plurality of GUIs that are generated by the system 10.

FIG. 4 is a flow diagram illustrating an embodiment of a method of generating a plurality of GUIs. The steps performed are as follows:

A1. The common data set that is to be used to generate each of the plurality of GUIs is stored in the memory of the system. This common data set comprises a plurality of data objects with each data object indicating a type for the data object.
A2. GUI generation information for each of the GUIs provided by the system is also stored in the memory of the system. For each GUI, the corresponding GUI generation information defines a type of GUI element that is to be used to represent each data object type on the GUI.
A3. The system subsequently receives a request for one of the plurality of GUIs.
A4. The processor retrieves the GUI generation information that corresponds to the requested GUI from the memory. The processor then initiates an iterative data object processing procedure, as defined in steps A5 to A8, in which the each of the data objects in the common data set is processed using the retrieved GUI generation information.
A5. For a data object, the processor identifies the data object type. To do so, the processor inspects ‘type’ field included in the data object and obtains the value/identifier for the data object type.
A6. The processor then uses the retrieved GUI generation information that corresponds to the requested GUI to determine the type of GUI element that is to be used to represent the identified data object type.
A7. Then, for each set of data values that is included in the data object, the processor creates GUI element of the determined type and displays the values in the set of data values using the created GUI element.
A8. The processor then determines if all of the data objects in the common data set have been processed. If not, then the processor proceeds to implement the data object processing procedure for the next data object in the common data set and returns to step A5. If all of the data objects in the common data set have been processed, then the entire data object processing procedure has been completed and the processor proceeds to step A9.
A9. Once all of the data objects in the common data set have been processed, and corresponding GUI elements have been created for each data object, then the requested GUI is provided to the requesting user.

It will be appreciated that individual items described above may be used on their own or in combination with other items shown in the drawings or described in the description and that items mentioned in the same passage as each other or the same drawing as each other need not be used in combination with each other. In addition, the expression “means” may be replaced by actuator, system, unit or device as may be desirable. In addition, any reference to “comprising” or “consisting” is not intended to be limiting in any way whatsoever and the reader should interpret the description and claims accordingly.

Furthermore, although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. For example, those skilled in the art will appreciate that the above-described invention might be equally applicable to GUIs other than those provided by a system implementing an Internet-based offers service.

In addition, in the embodiments described above, the data object type is defined using terminology that reflects the expected implementation of a data object on the subscriber input GUI of an Internet-based offers system (i.e. polar, single selection alternative, etc). However, those skilled in the art will recognise that the data object type could be identified using any alternative terminology or other reference means, provided that the GUI generation information defines a corresponding type of GUI element.

Moreover, it should be noted that for a conventional web-based system, a web page containing a number of GUI elements/widgets would be typically be generated on a server, sent to a user's client computer device, and rendered in a web browser on the client. In contrast, for an app implementing a GUI, it is typical for the GUI generation information used to generate the GUI to be sent by a server to a device on which the app is being run, so that the app can generate the GUI locally on the device. It is also possible that a web-based system could implement a process similar to that of an app, by having a server send the GUI generation information to a client computer device, so that the computer device can generate the GUI locally. Such system arrangements are therefore equally applicable to the embodiments described herein.

1. A method of operating a computer system in order to generate a plurality of graphical user interfaces, the method comprising:
storing a common data set comprising a plurality of data objects, each data object indicating a type for the data object;
storing graphical user interface generation information for each of the plurality of graphical user interfaces, the graphical user interface generation information of each graphical user interface defining a type of graphical user interface element that is to be used to represent each data object type on the graphical user interface;
upon receipt of a request for one of the plurality of graphical user interfaces, creating one or more graphical user interface elements for each data object in the common data set, wherein the type of graphical user interface elements created for the data object is determined using the corresponding graphical user interface generation information.

2. The method of claim 1, wherein the step of creating one or more graphical user interface elements for each data object in the common data set comprises:
for each data object in the common data set, identifying the data object type, using the corresponding graphical user interface generation information to determine the type of graphical user interface element that is to be used to represent the identified data object type, and creating one or more graphical user interface elements of the determined type.

3. The method of claim 1, wherein each of the plurality of data objects includes one or more sets of data values.

4. The method of claim 3, wherein, for each data object in the common data set, a graphical user interface element is created for each of the one or more sets of data values included in the data object.

5. The method of claim 1, wherein each of the plurality of data objects relates to a category of data.

6. The method of claim 5, wherein for each data object in the common data set, a graphical user interface element is created for each of the one or more sets of data values included in the data object, and wherein each of the one or more sets of data values included in a data object that relates the category of data comprises values that relate to a sub-category of said category of data.

7. The method of claim 1, wherein the graphical user interface element is an interactive control that displays and allows the selection of one or more data values.

8. A computer program comprising computer readable code which, when run on a computer device, causes the computer device to perform the method as claimed in claim 1.

9. A computer program product comprising a computer readable medium and the computer program as claimed in claim 8, wherein the computer program is stored on the computer readable medium.

10. A system for generating a plurality of graphical user interfaces, the system comprising:
a memory configured to store a common data set comprising a plurality of data objects, each data object indicating a type for the data object, and to store graphical user interface generation information for each of the plurality of graphical user interfaces, the graphical user interface generation information of each graphical user interface defining a type of graphical user interface element that is to be used to represent each data object type on the graphical user interface; and
a processor configured to, upon receipt of a request for one of the plurality of graphical user interfaces, create one or more graphical user interface elements for each data object in the common data set, including using the corresponding graphical user interface generation information to determine the type of graphical user interface element to be created for the data object.

11. The system of claim 10, wherein the processor is configured to:
for each data object in the common data set, identify the data object type, use the corresponding graphical user interface generation information to determine the type of graphical user interface element that is to be used to represent the identified data object type, and create one or more graphical user interface elements of the determined type.

12. The system of claim 10, wherein each of the plurality of data objects stored in the memory includes one or more sets of data values.

13. The system of claim 12, wherein the processor is configured to create a graphical user interface element for each of the one or more sets of data values included in each data object in the common data set.

14. The system of claim 10, wherein the processor is configured to generate graphical user interface elements that provide an interactive control that displays and allows the selection of one or more data values.
